(19) United States
(12) Patent Application Publication
(10) Pub. No.: US 2026/0245535 A1
(43) Pub. Date: Aug. 20, 2026

(54) Active Noise Reduction in a Vehicle

(71) Applicant: Bayerische Motoren Werke Aktiengesellschaft, Muenchen (DE)

(72) Inventors: Christoph Riebel, Muenchen (DE); Thomas Sailer, Pfaffenhofen an der Ilm (DE); Jens Heinemann, Muenchen (DE)

(21) Appl. No.: 19/165,312

(22) PCT Filed: Oct. 9, 2023
(86) PCT No.: PCT/EP2023/077842

§ 371 Date: Sep. 15, 2025

(30) Foreign Application Priority Data
Mar. 20, 2023 (DE) 10 2023 106 847.4

(51) Int. Cl. G10K 11/178

(52) U.S. Cl. CPC G10K 11/17821; G10K 2210/1282

(57) ABSTRACT

A method for active noise reduction in a vehicle includes a step of acquiring vehicle state data, wherein the vehicle state data describe a current condition of the vehicle. The method also includes determining activation data, wherein the activation data describe whether the determined vehicle state data are associated with at least one predetermined range. The method further includes activating active noise reduction, deactivating active noise reduction, or putting active noise reduction into an energy saving mode based on the determined activation data.

The present application is the U.S. national phase of PCT Application PCT/EP2023/077842 filed on Oct. 9, 2023, which claims priority of German patent application No. 10 2023 106 847.4 filed on Mar. 20, 2023, the entire contents of which are incorporated herein by reference.

### TECHNICAL FIELD

The present disclosure relates generally to the field of vehicles, and more specifically to active noise reduction in vehicles.

### BACKGROUND

Noises may occur in vehicles, especially while driving, which may be perceived as disturbing by a driver or an occupant of the vehicle.

There is a need for improved background noise in the vehicle, in particular, to reduce noise in the vehicle interior.

### SUMMARY

At least some embodiments described herein provide improved noise reduction in a vehicle interior.

According to some embodiments, a method for active noise reduction is provided in a vehicle. In one version, the method involves the acquisition of vehicle state data, in particular with at least one sensor, and/or in particular an evaluation of data of an ECU. In one version, the vehicle state data describe a state of the vehicle, in particular a current state. In one version, the vehicle state data describe at least one speed of the vehicle, in particular a current speed of the vehicle. In one version, the vehicle state data additionally or alternatively describe a gear of the vehicle, especially if the vehicle has a switchable transmission with one or more gears. In one version, the vehicle state data additionally or alternatively describe a revolution rate of at least one rotating component of the vehicle. In one version, the vehicle state data additionally or alternatively describe at least one temperature, in particular at least one temperature of a component of the vehicle or a temperature of the environment. In one version, the method involves a determination of activation data. In one version, the activation data describe whether the determined vehicle state data are assigned to a predetermined area and/or several predetermined areas, or fall into one or more predetermined areas, in particular a predetermined area and/or several predetermined areas of a state space of the vehicle state or are assigned to it, in particular to a predetermined range for a speed and/or a predetermined range for a gear and/or to a predetermined range for a revolution rate of at least one rotating component of the vehicle and/or to a range for a temperature. In one version, the method also involves activation of the active noise reduction, in particular in a vehicle interior of the vehicle, based on the determined activation data, in particular if the determined activation data describe that vehicle state data are assigned to one or more predetermined ranges or fall into these range(s). In one version, the method also involves deactivating the active noise reduction, especially in a vehicle interior of the vehicle, based on the determined activation data. In one version, the method also involves setting the active noise reduction into an energy-saving mode based on the determined activation data. In one version, an energy saving mode is specifically a reduction of a CPU clock speed and/or an analysis frequency of the active noise reduction.

In one or more embodiments this can advantageously enable active noise reduction to be deactivated, and especially then or only then to be activated if the activation data describe that vehicle state data are assigned to one or more predetermined ranges or fall within one or more predetermined ranges. Advantageously, in one version this can reduce the energy required or used for monitoring vehicle interior noise, especially compared to active noise reduction methods which, at least essentially, are always active, in particular regardless of vehicle state data and/or activation data.

In some embodiments, a component of the vehicle can be a drive shaft, a generator, a wheel, a refrigerant compressor, compressor, especially the refrigerant compressor, a component that is usually installed in the vehicle as an assembly, or the like.

In some implementations, the predetermined area and/or the several predetermined areas is or are assigned to a first-order hum of at least one vehicle component. In one version, the predetermined area and/or the several predetermined areas is or are additionally or alternatively assigned to a second-order hum of at least one vehicle component. In one version, the predetermined area and/or the several predetermined areas is or are additionally or alternatively assigned to a hum from a superposition of at least two vehicle components, in particular, at least two vehicle components with a hum of the same order and/or a different order.

In some embodiments, this can advantageously allow activation of the active noise reduction to be limited to acoustically perceptible natural frequencies of one or more vehicle components, in particular, to a superposition of natural frequencies that is acoustically perceptible. In one version, this can advantageously make it possible that in particular at least part of a computing capacity of a control unit (“electronic control unit”; ECU), which is used for active noise reduction can be released and/or is free, in particular less computing capacity is required when the active noise reduction is (temporarily) deactivated, especially based on the activation data.

In some implementations, the hum has a recuperation hum of a generator of the vehicle, especially in a predetermined range, as described herein, or is a corresponding recuperation hum. In one version, the hum (in addition or alternatively) has a floating hum, in particular a floating hum from superposition of in particular acoustic emissions and/or acoustically perceptible natural vibrations, of at least two vehicle components or is a corresponding floating hum. In one version the hum (in addition or alternatively) has a hum, in particular acoustic emissions and/or acoustically perceptible natural vibrations of a refrigerant compressor or is a corresponding hum.

In some implementations, the recuperation hum is an excitation of the first drive shaft order in overrun mode, especially at 50 km/h or more and/or no more than 60 km/h, which corresponds or can correspond in particular to a number of revolutions of the drive shaft of no more than 1, 900 and/or at least 800 per minute. In one version, the recuperation hum is generated by a deceleration torque of a recuperation of the generator.

In some embodiments, the floating hum is a superposition of the second drive shaft order with the wheel order at a speed of at least 90 km/h and/or at most 100 km/h.

In some embodiments, the hum of the refrigerant compressor corresponds to a low mechanical decoupling, by which the first harmonic order of the compressor of the refrigerant compressor is transferred to the internal chamber.

In some embodiments, there are a number of (acoustic) problems to be calculated, which, at least essentially, do not take place in parallel to each other, but in the currently available software solutions usually lead to the full loading of a CPU, in particular in the control unit. Advantageously, in one version a load on the CPU, especially a processor in an ECU, can be reduced, especially in such a way that the processor is “loaded” in one version (only) based on the activation data. In one version, a CPU load can be reduced by more than 40%, especially more than 60%, in particular compared to solutions in which active noise reduction is at least essentially permanently activated.

Advantageously, in some implementations a method described herein can make it possible to actively reduce the noise of (perceptible) acoustic emissions or natural vibrations of components and/or assemblies of the vehicle in a targeted manner and in particular active noise reduction is activated, in particular only if the vehicle is in a vehicle state in which these acoustic emissions occur or may occur.

In some embodiments, the method involves deactivation or activation of at least one sensor, especially all sensors, in particular based on the activation data. In one version, the method involves deactivating or activating at least one sensor, in particular all sensors that are not involved in the acquisition of vehicle state data, in particular based on the activation data. In one version, the method involves deactivating or activating at least one sensor, in particular all sensors that are not involved in the acquisition of vehicle state data, in particular based on the activation data, wherein the sensor(s) are combined with the active noise reduction in the vehicle or are used for active noise reduction in the vehicle. In one version, at least one sensor is deactivated when noise reduction is deactivated, especially based on the activation data.

In some implementations, advantageously this can make it possible (further) reduce energy consumption, in particular such that little or no energy has to be used for sensors, in particular if the activation data do not assign the vehicle state data to the one or more predetermined ranges or if the determination of the activation data results or has resulted in this. In other words, in one version this can make it possible that the at least one sensor, in particular all sensors related to active noise reduction in the vehicle, are deactivated based on the activation data, in particular if the activation data do not assign the vehicle state data to the one and/or more predetermined ranges or if the determination of the activation data results or has resulted in this.

In some embodiments, the method involves deactivating at least one sensor, in particular all sensors, in particular based on the activation data, in particular if the determination of the activation data shows that the have or will predetermined range and/or the multiple predetermined ranges, in particular within a predetermined forecast period of the activation data. In one version, the method involves activating at least one sensor, especially all sensors, in particular based on the activation data, in particular, where the determination of the activation data shows that the vehicle state data have reached or are reaching or will reach the predetermined range and/or the several predetermined ranges, in particular within a predetermined forecast period, in particular of less than one second, and in particular less than 10 milliseconds, of the activation data.

In some embodiments, this can advantageously deactivate and/or activate active noise reduction or active noise reduction sensors, in particular based on the activation data, and in particular the energy to operate the sensors can be advantageously saved if or while active noise reduction is not activated and, in particular, energy is only consumed by the sensors when the active noise reduction is active, in particular based on the activation data.

In one or more implementations, the method involves deactivating at least one means or device of the vehicle, in particular based on the activation data, which is related to or involved in the noise reduction.

In some implementations, the method involves activating at least one means or device of the vehicle, in particular based on the activation data, that is related to or involved in the noise reduction.

In some embodiments, this can advantageously (further) reduce energy consumption, in particular the overall noise reduction, in particular based on the activation data, is not active or not activated.

In some embodiments, such a means or device may be an audio system, an audio amplifier, a loudspeaker, or the like, in particular software with appropriate hardware designed for this software, which is or can be in particular related to or assigned to the active noise reduction.

In some implementations, the predetermined range and/or predetermined ranges is/are determined, in particular dynamically, by means of a simulation, by means of road tests and/or by means of artificial intelligence, and in particular during the operation of the vehicle. In one version, the artificial intelligence is trained with the help of data from the simulation and/or from the driving tests, in particular in such a way that the artificial intelligence learns ranges of vehicle states that are associated with higher acoustic emissions in the vehicle interior and these are in particular traceable to or associated with a state (range) of at least one component of the vehicle and/or a state (range) of at least one combination of components.

As a result, in some implementations a small (er) predetermined range can advantageously be determined, in particular a range in which the active noise reduction is not activated can be larger, in particular an energy saving can be greater as a result than in particular when the active noise reduction is always activated.

In some embodiments, the method also involves an output of a destructive inference due to the activated active noise reduction, in particular based on the (determined) activation data.

In some embodiments, the method involves detecting vehicle interior sound with at least one sensor, in particular with at least one microphone, in particular based on the activation data, especially if the active noise reduction is activated or active. In one version, the method also includes modulating, in particular adjusting, the active noise reduction of the output o H the active noise reduction based on the acquired vehicle interior sound.

As a result, in one version, particularly while the active noise reduction is activated (in particular based on the activation data), a feedback loop for the activated noise reduction can be implemented, in particular the at least one sensor can be used for this purpose, so that, in one version, the activated active noise reduction can be improved, in particular vehicle interior noise can be or will be further or better reduced.

It is within the scope of the disclosure that the steps the method described above are carried out in a different order and/or that steps of the method are combined and/or that a step of the method is integrated into another step of the method.

According to at least one implementation, a system for active noise reduction is provided in a vehicle. In some versions, the system is set up to perform a method described herein and/or has: means for acquiring vehicle state data; means for identifying activation data; and/or means for activating active noise reduction, in particular means for active noise reduction.

In some embodiments, means for acquiring, especially vehicle state data, are sensors.

The terms “comprises”, “includes”, “involves”, “exhibits”, “has”, “with”, or any other variation thereof, as used herein, are intended to cover non-exclusive inclusion. For example, a method or apparatus which comprises or exhibits a list of elements is not necessarily limited to these elements but may include other elements that are not expressly listed or that are inherent in such a method or device.

Further, unless expressly stated otherwise, “or” refers to an inclusive or and not an exclusive “or”. For example, a condition A or B is satisfied by one of the following conditions: A is true (or exists) and B is false (or non-existent), A is false (or non-existent), and B is true (or exists), and both A and B are true (or exist).

The term ‘a’, as used herein, is defined in the sense of 'one or more'. The terms “another” and “a further” and any other variant of them are to be understood in the sense of “at least one more”.

A system and/or means within the meaning of the present invention can be implemented in hardware and/or software, in particular with at least one, in particular digital, processing unit, in particular a microprocessor unit (CPU), graphics card (GPU), or the like, preferably connected to a memory and/or bus system for data or signals, and/or one or more programs or program modules. The processing unit may be designed to process instructions implemented as a program stored in a storage system, to acquire input signals from a data bus and/or to output signals to a data bus. A storage system may contain one or more, in particular different, storage media, in particular optical, magnetic, solid-state, and/or other non-volatile media. The program may be designed to embody or carry out the methods described herein, so that the processing unit can carry out the steps of such methods and thus in particular operate or monitor the vehicle interior, in particular active noise reduction in the vehicle interior.

A computer program product may have, in particular may be, a computer-readable and/or non-volatile storage medium for storing a program or instructions, or may have a program or instructions stored on it. In one version, execution of this program or instructions by means of a system or controller, in particular a computer or an arrangement of several computers, causes the system or controller, in particular the computer(s), to carry out a method or one or more of the steps thereof described herein, or the program or instructions are set up for this purpose.

In particular, the computer program may be stored on a non-volatile data carrier. Preferably, this is a data carrier in the form of an optical data carrier or a flash memory module. This can be advantageous if the computer program is to be dealt with independently of a processor platform on which the one or more programs are to be executed. In another implementation, the computer program may exist as a file on a computing unit, in particular on a server, and may be downloadable over a data link, such as the Internet, or a dedicated data link, such as a proprietary or local area network. In addition, the computer program have a plurality of interacting individual program modules. In particular, the modules can be configured or at least be used in such a way that they can be executed in the sense of distributed computing on different devices (computers or processor units that are geographically separated from each other and are connected to each other via a data network).

The system can accordingly have a program memory in which the computer program is stored. Alternatively, the system can also be set up to access a computer program available on one or more servers or other data processing units via a communication link, in particular to exchange data with the computer program that is used during the course of the method or computer program or that constitute outputs of the computer program.

At least some implementations, one or more, in particular all, steps of the method are carried out completely or partially automatically, in particular by the control system or the means thereof.

The features and advantages that are described above will become more readily apparent to those of ordinary skill in the art by reference to the following detailed description and accompanying drawings.

### BRIEF DESCRIPTION OF THE DRAWINGS

FIG. 1 schematically shows a method for active noise reduction in a vehicle; and

FIG. 2 schematically shows a system for active noise reduction in a vehicle.

### DETAILED DESCRIPTION

Elements depicted in the figures are not necessarily to scale. Rather, the various elements depicted in the figures are reproduced in such a way that the function and general purpose thereof are comprehensible to the person skilled in the art. Connections and couplings between functional units and elements shown in the figures can also be implemented as indirect connections or couplings, unless expressly stated otherwise. Functional units can be implemented in particular as hardware, software or a combination of hardware and software.

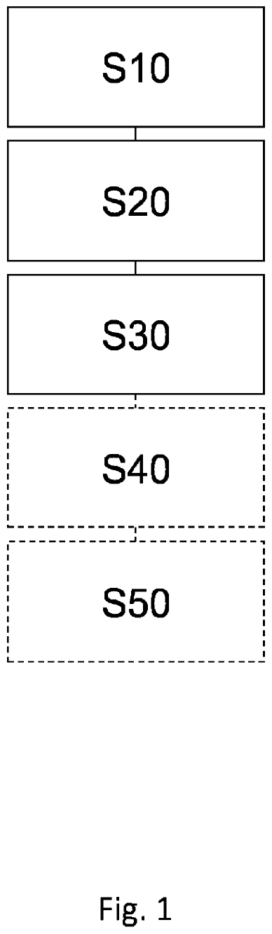

FIG. 1 schematically shows a method for active noise reduction in a vehicle. Acquiring vehicle state data is schematically depicted in FIG. 1, in particular with S10. Determination of activation data S20 in one version includes in particular the assignment of the acquired vehicle state data to one and/or more predetermined ranges, in particular for one or more components of the vehicle. Based on the determined activation data, active noise reduction is activated S30, especially if the determined activation data assigns the vehicle state data to the one and/or more predetermined ranges. In FIG. 1 activation S40 of at least one sensor based on the determined activation data is also schematically shown in dashed form. Furthermore, an output S50 of destructive interference by the active noise reduction (activated based on the determined activation data) is shown dashed.

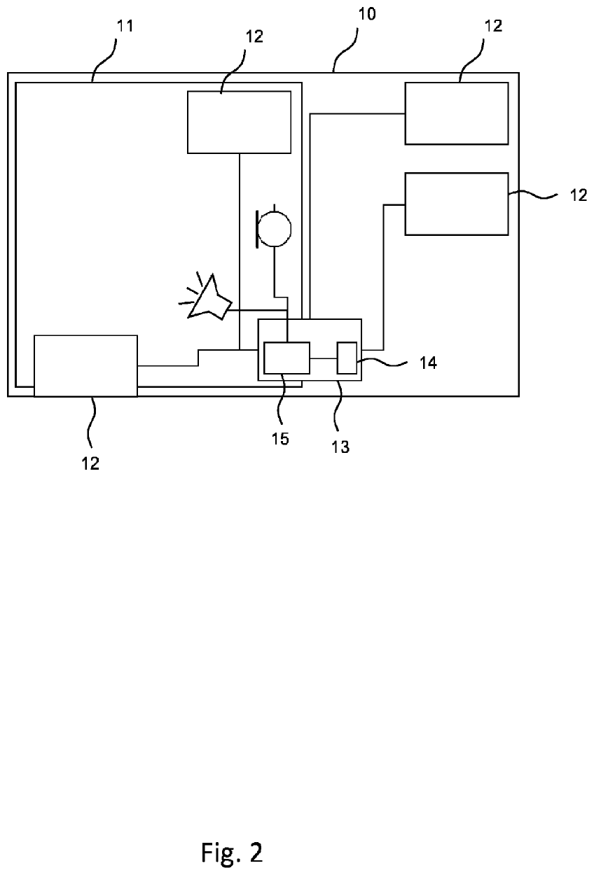

FIG. 2 schematically shows a system for active noise reduction in a vehicle. The system is shown in a vehicle 10 with an interior compartment 11, wherein it should be noted that the parts of the system shown here, in one version, can also be arranged differently within the vehicle 10. In FIG. 2, means 12 for acquiring vehicle state data, means 13 for determining activation data, and means 14 for activating active noise reduction and means 15 for active noise reduction are also depicted schematically. The means 12 for acquiring vehicle state data are depicted in particular distributed over the entire vehicle, in particular because in one version it can be or is sensors which are equipped to detect or determine the at least one vehicle state, in particular acceleration sensors, speed sensors, position sensors, acoustic sensors, or the like. The means 12 are shown in the schematic FIG. 2 with a data connection to means 13 for the determination of activation data. In the illustration of FIG. 2, the means 13 for determining activation data have means 14 for activating active noise reduction and means 15 for active noise reduction, in particular the means 15 for active noise reduction have at least one loudspeaker, as shown by way of example, in particular at least one sensor, in particular a microphone, in particular for a feedback loop for active noise reduction.

While at least one exemplary embodiment has been described above, it should be noted that a large number of variations to it exists. It should also be noted that the examples described are only non-limiting examples and are not intended to limit the scope, applicability or configuration of the devices and methods described herein. Rather, the preceding description is given to the person skilled in the art to provide instructions for the implementation of at least one exemplary embodiment, wherein it is understood that various changes may be made to the functioning and arrangement of the elements described in an exemplary embodiment without deviating from the subject matter defined in the attached claims as well as the legal equivalents thereof.

### REFERENCE SIGN LIST

10 Vehicle
12 Means of acquiring vehicle data
13 Means of determining activation data
14 Means for activation
S10 Acquiring vehicle state data
S20 Determining activation data
S30 Activating, deactivating, or putting into an energy-saving mode
S40 Deactivating or activating at least one sensor
S50 Outputting an interference

1-10. (canceled)

11. A method for active noise reduction in a vehicle, comprising:
acquiring vehicle state data, wherein the vehicle state data describe a current condition of the vehicle;
determining activation data, wherein the activation data describe whether the determined vehicle state data are associated with at least one predetermined range;
activating active noise reduction, deactivating active noise reduction, or putting active noise reduction into an energy saving mode based on the determined activation data.

12. The method according to claim 11, wherein:
the at least one predetermined range is associated with a first-order hum of at least one vehicle component, a second-order hum of the at least one vehicle component.

13. The method according to claim 12, wherein
the first-order hum or the second-order hum has or is a recuperation hum of a generator or a hum of a refrigerant compressor.

14. The method according to claim 11, wherein the at least one predetermined range is associated with a hum from a superposition of at least two vehicle components.

15. The method according to claim 14, wherein the hum has or is a floating hum from the superposition of the at least two vehicle components.

16. The method according to claim 11, further comprising deactivating or activating at least one sensor that is not involved in an acquisition of vehicle state data, based on the activation data.

17. The method according to claim 16, further comprising deactivating or activating all sensors that are not involved in the acquisition of vehicle state data, based on the activation data.

18. The method according to claim 16, wherein the at least one predetermined range is determined at least in part using a simulation, road tests or artificial intelligence.

19. The method according to claim 18, further comprising:
acquiring vehicle interior sound with at least one sensor based on the activation data.

20. The method according to claim 19, further comprising providing an output based on the acquired vehicle interior sound.

21. The method according to claim 11, wherein the at least one predetermined range is determined at least in part using a simulation, road tests or artificial intelligence.

22. The method according to claim 11, further comprising: outputting a destructive inference due to an activated active noise reduction.

23. The method according to claim 11, further comprising:
acquiring vehicle interior sound with at least one sensor based on the activation data.

24. The method according to claim 23, wherein the at least one sensor is at least one microphone.

25. The method according to claim 23, further comprising providing an output based on the acquired vehicle interior sound.

26. A system for active noise reduction in a vehicle, comprising:
means for acquiring vehicle state data, wherein the vehicle state data describe a current condition of the vehicle;
means for determining activation data wherein the activation data describe whether the determined vehicle state data are associated with at least one predetermined range; and
means for activating active noise reduction using active noise reduction.

27. A non-transitory storage medium storing instructions which, when executed by one or more computers cause the one or more computers to carry out a method according to claim 11.
